(19) United States
(12) Patent Application Publication
(10) Pub. No.: US 2013/0103465 A1
(43) Pub. Date: Apr. 25, 2013

(54) PROMOTING PHARMACEUTICAL PRODUCTS

(71) Applicant: Farouk Meralli, Vancouver (CA)

(72) Inventor: Farouk Meralli, Vancouver (CA)

(73) Assignee: mClinica Inc., a Delaware corporation

(21) Appl. No.: 13/278,808

(22) Filed: Oct. 21, 2011

(51) Int. Cl. G06Q 30/02

(52) U.S. Cl. 705/14.4

(57) ABSTRACT

Among other things, an association is maintained between a promotional campaign for a product (such as a pharmaceutical product) and an identifier that is unique with respect at least one of the campaign, the product, or a stakeholder associated with the product. In association with the unique identifier, information is stored about at least one of the following: the campaign, the product, the stakeholder, or activities of the stakeholder with respect to the product.

### BACKGROUND

This description relates to promoting pharmaceutical products.

Traditional pharmaceutical product promotion by pharmaceutical manufacturers relies predominately on independent efforts targeted to an individual physician or retailer or patient. Generally, these and other parties who have an interest in such promotion are known, as stakeholders.

### SUMMARY

In general, in an aspect, an association is maintained between a promotional campaign for a product (such as a pharmaceutical product) and an identifier that is unique with respect at least one of the campaign, the product, or a stakeholder associated with the product. In association with the unique identifier, information is stored about at least one of the following: the campaign, the product, the stakeholder, or activities of the stakeholder with respect to the product.

Implementations may include one or more of the following features. The stakeholder includes at least one of an end user of the product, a physician who prescribes or recommends the product, a manufacturer of the product, or a retailer of the product. The unique identifier is provided to a stakeholder who is an end user of the product. The unique identifier is provided to the end user by the end user's physician or by a retailer that serves the end user or both. The information about the activities of the stakeholder is provided from a mobile device of the stakeholder. The information is stored, in association with the unique identifier, about activities of multiple stakeholders with respect to the product. The unique identifier is associated with attributes of the associated campaign. The stored information is analyzed with respect to the campaign. The stored information is analyzed with respect to at least one other campaign. Actionable attributes of the campaign are carried out. The actionable attributes include at least one of customized communications, timed refill reminders, retailer rebates, or end user discounts. Reports are provided based on the stored information. The information includes responses of the stakeholder. Messages are sent to the stakeholder. The messages include information including at least one of safety and efficacy of the product, affordability features of the product, discounts, promotions, coupons, rebates, medication adherence, education programs, and drug interactions. The messages include customized communications or discounts that are based on relationships of the product to other products. A sequence of activities with respect to the product is tracked. The activities of the sequence include at least one of product recommendation or prescription by a physician, dispensing of the product to the end user, and use of the product by the end user. The attributes of the campaign include geography.

In general, in an aspect, an apparatus includes a processor to maintain an association between a promotional campaign for a pharmaceutical product and an identifier that is unique with respect at least one of the campaign, the product, or a stakeholder associated with the product. Storage holds, in association with the unique identifier, information about at least one of the following: the campaign, the product, the stakeholder, or activities of the stakeholder with respect to the product.

In general, in an aspect, an apparatus includes means for maintaining an association between a promotional campaign for a pharmaceutical product, and an identifier that is unique with respect at least one of the campaign, the product, or a stakeholder associated with the product, and means for storing, in association with the unique identifier, information about at least one of the following: the campaign, the product, the stakeholder, or activities of the stakeholder with respect to the product.

In general, in an aspect, a computer-implemented method includes, with respect to a promotional campaign for a pharmaceutical product, sending messages to mobile devices of stakeholders associated with the product, the messages being based on actionable attributes of the campaign and identified based on a unique identifier associated with the campaign.

These and other aspects, features, and implementations can be expressed as methods, program products, apparatus, systems, components, user interfaces, databases, means or steps for performing functions, and in other ways.

Other aspects, features, and implementations will become apparent from the following description and from the claims.

### DESCRIPTION

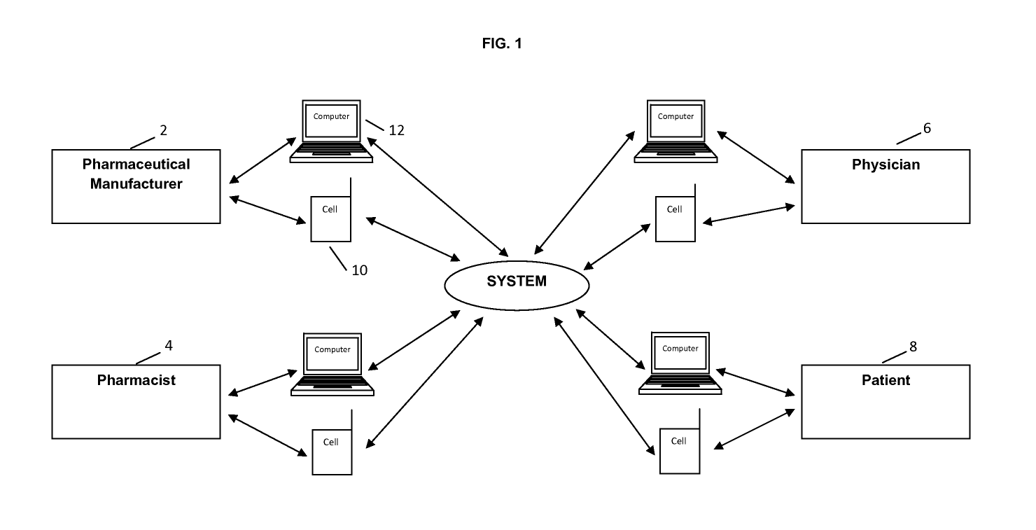

FIG. 1 is a diagram representing primary stakeholders that interact with a promotion management system and the devices they use to interact with the promotional campaign management system (which is an example of what we sometimes refer to as simply the system).

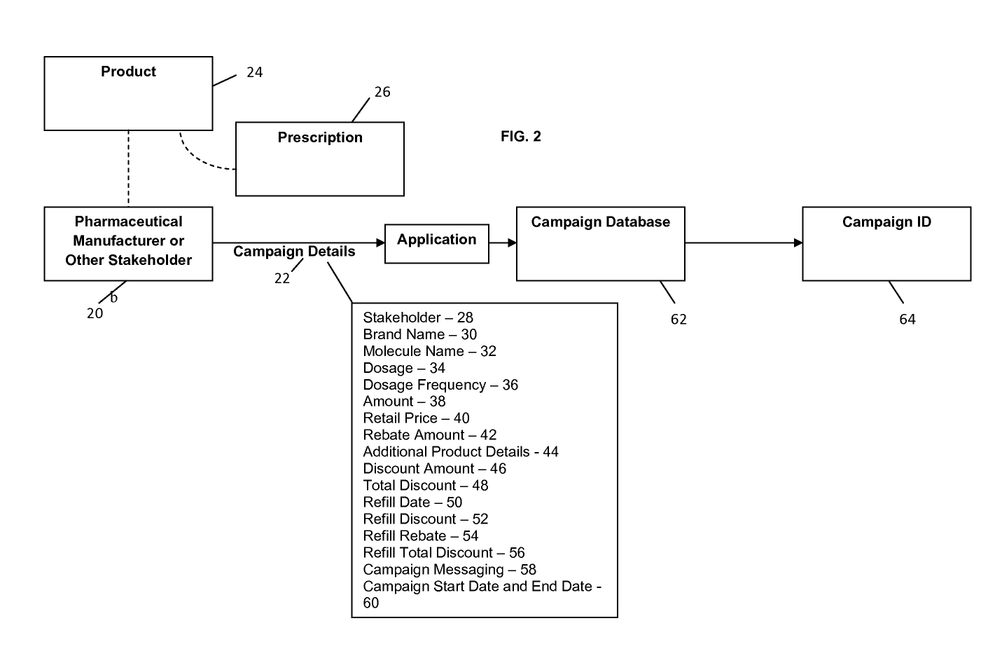

FIG. 2 is a diagram showing an example process of associating attributes of a pharmaceutical product promotional campaign with a unique identifier (that we sometimes refer to, for example, as a campaign ID).

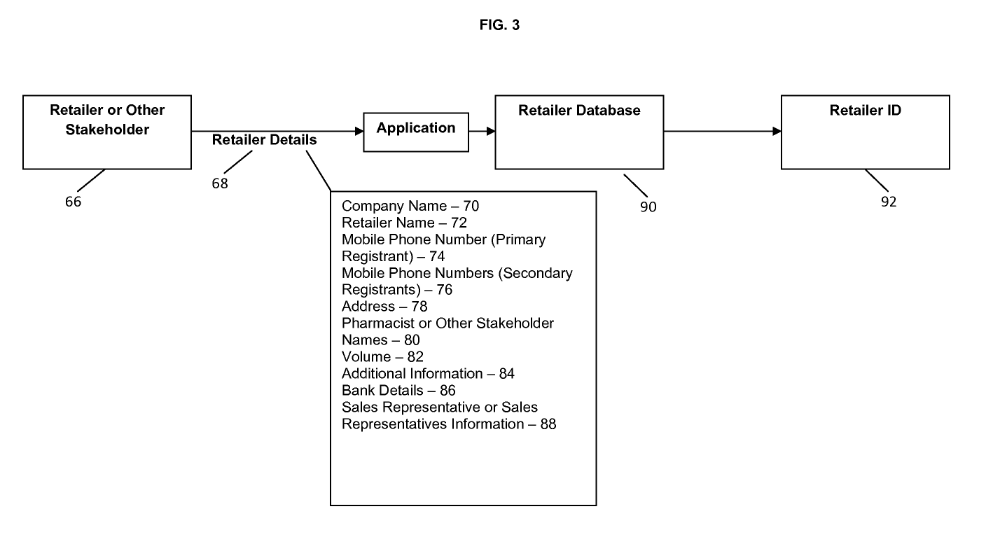

FIG. 3 is a diagram showing an example process of associating attributes of a pharmaceutical retailer with a unique identifier (that we sometimes refer to, for example, as a retailer ID).

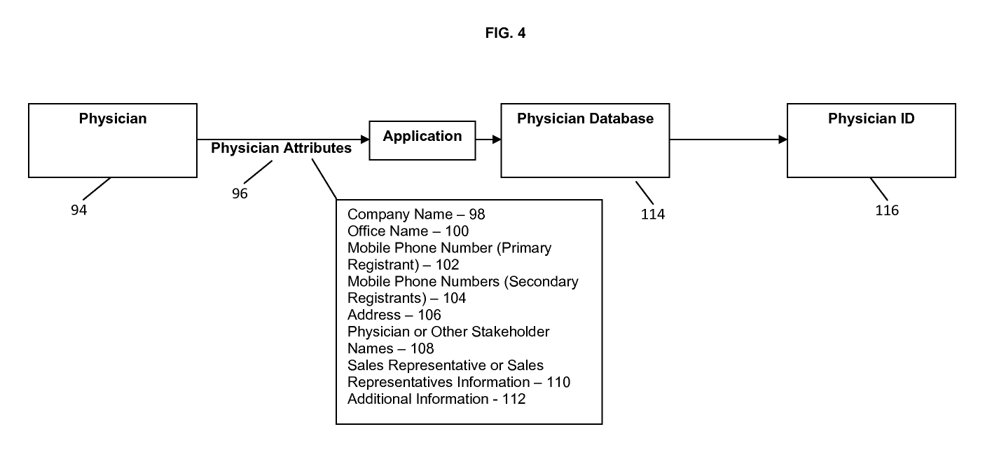

FIG. 4 is a diagram showing an example process of associating attributes of a particular physician with a unique identifier (that we sometimes refer to, for example, as a physician ID).

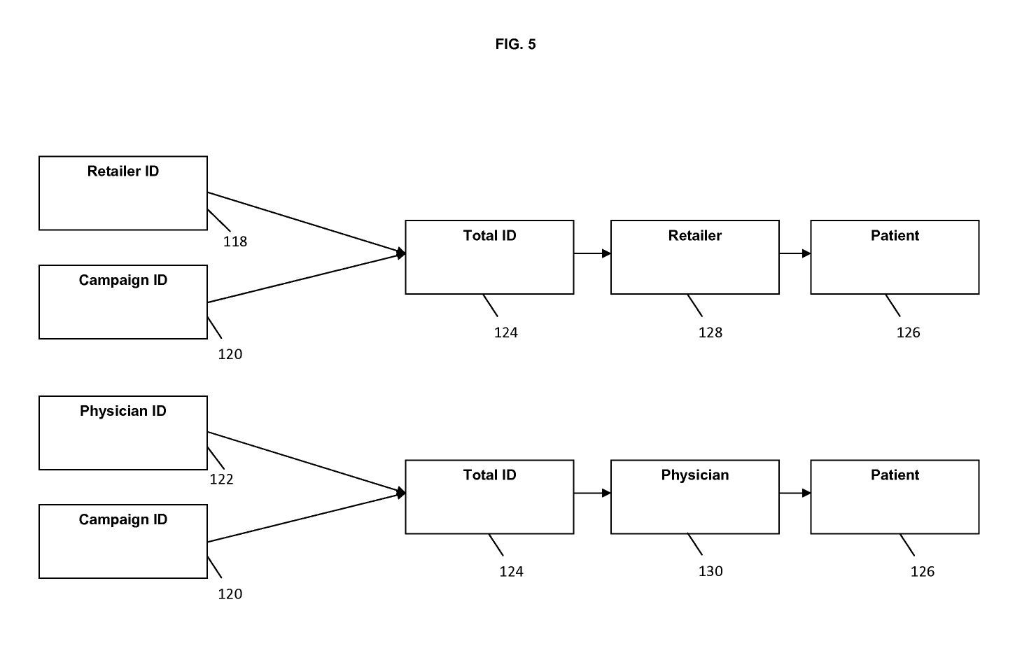

FIG. 5 is a diagram showing an example process of linking a retailer ID to a campaign ID and a physician ID to a campaign ID to create a unique identifier (that we sometimes refer to, for example, as a total ID).

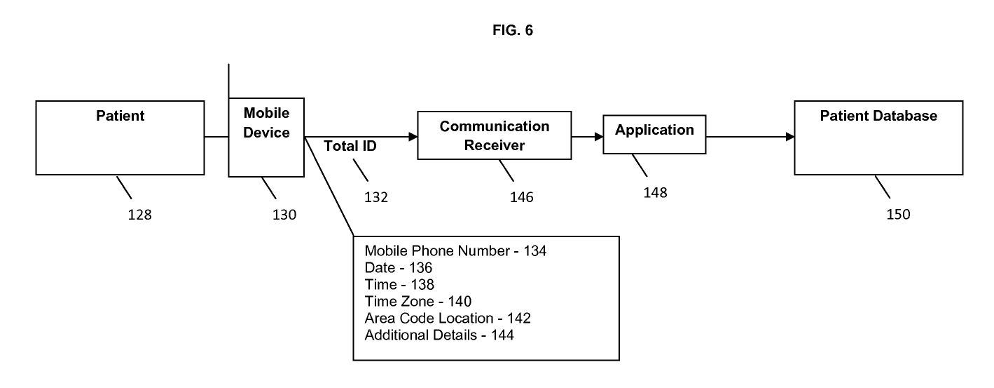

FIG. 6 is a diagram showing an example of how a patient sends a total ID to the system and how the collected information is received and stored by the system.

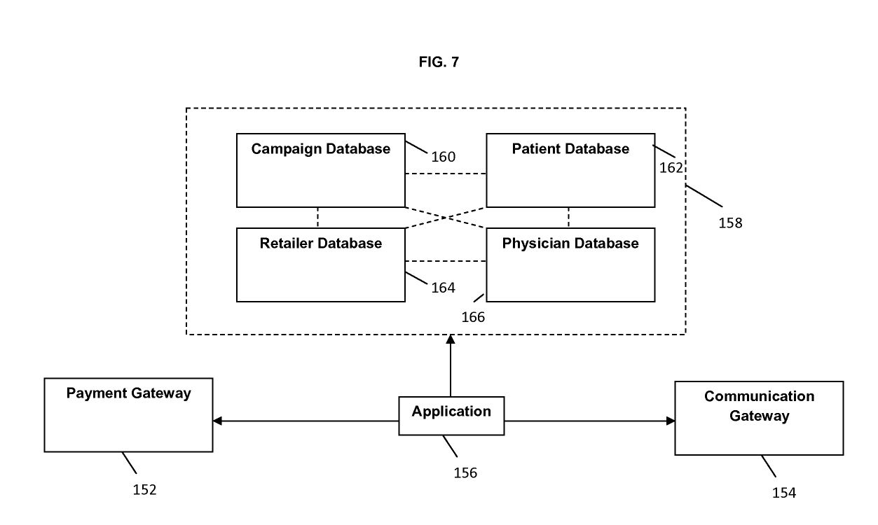

FIG. 7 is a diagram showing an example of how the system may be composed of various modules including a database, a banking gateway and a communication gateway.

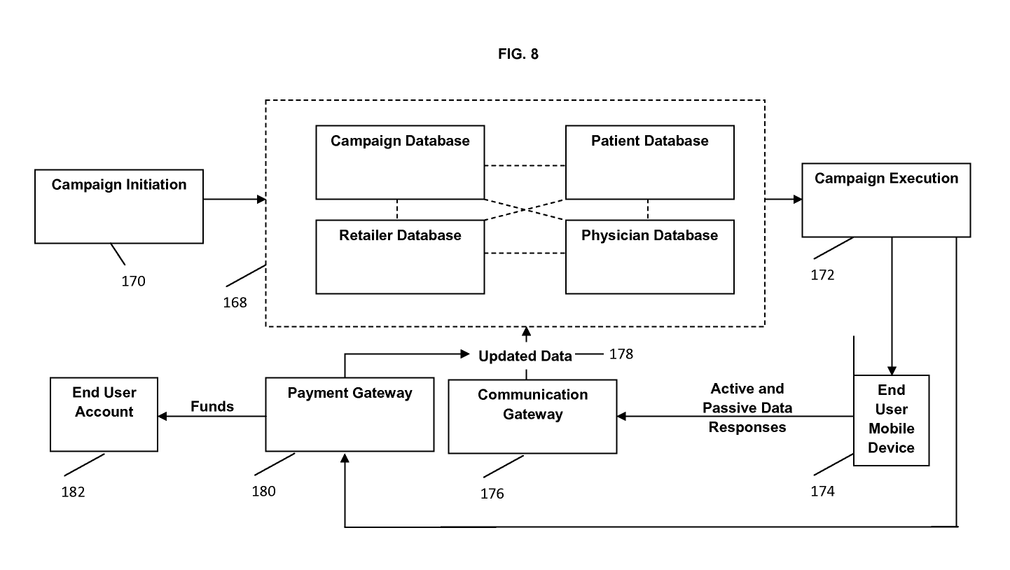

FIG. 8 is a diagram showing an example of how the system initiates and executes a campaign to various stakeholders and acts to passively and actively collect data to update stored information regarding pharmaceutical manufacturers, products, physicians, retailers and patients.

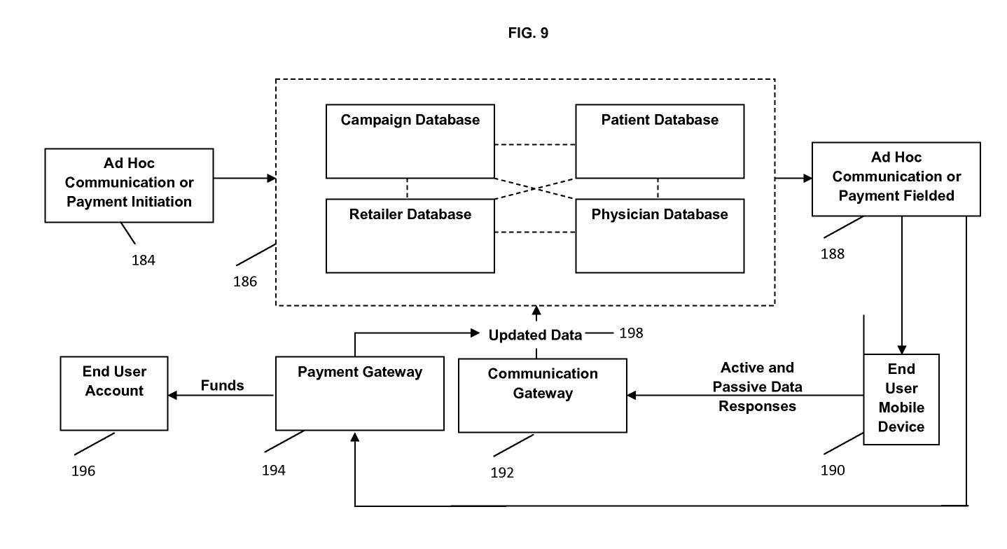

FIG. 9 is a diagram showing an example of how ad hoc messages can be initiated and executed to stakeholders and how responses can be passively and actively collected to update stored information regarding manufacturers, products, physicians, retailers, and patients.

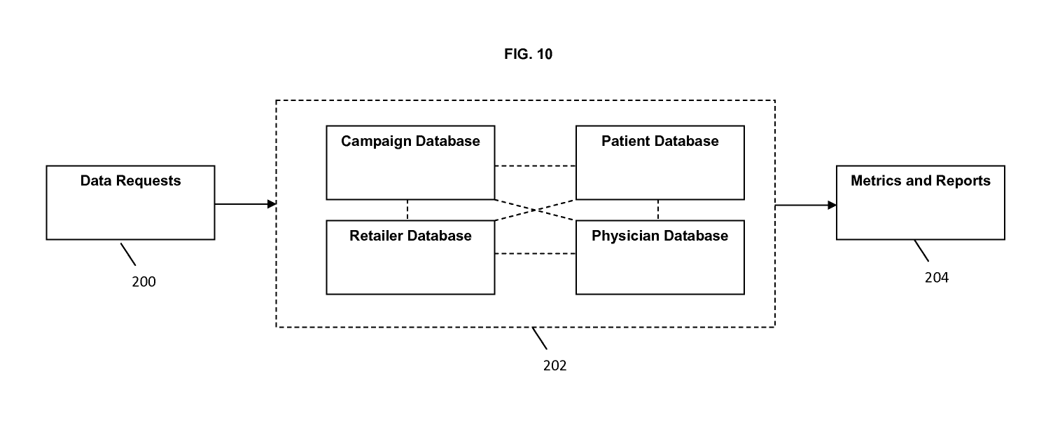

FIG. 10 is a diagram showing an example of how data stored within the system can be accessed and displayed through output formats such as metrics and reports.

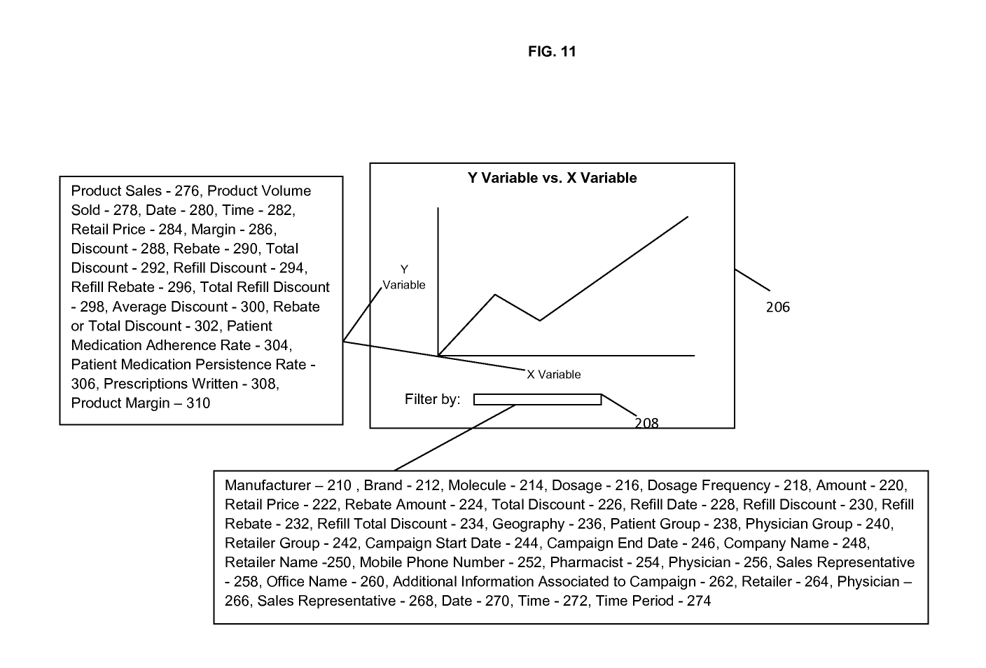

FIG. 11 is a diagram showing an example of how data variables stored in the system can be visualized in graphical form.

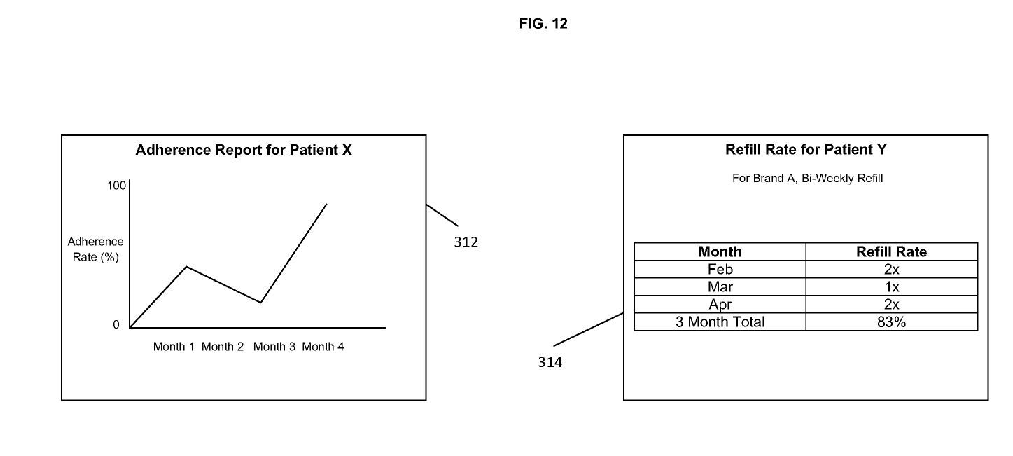

FIG. 12 is a diagram showing sample reports for the patient including an adherence report and a refill report.

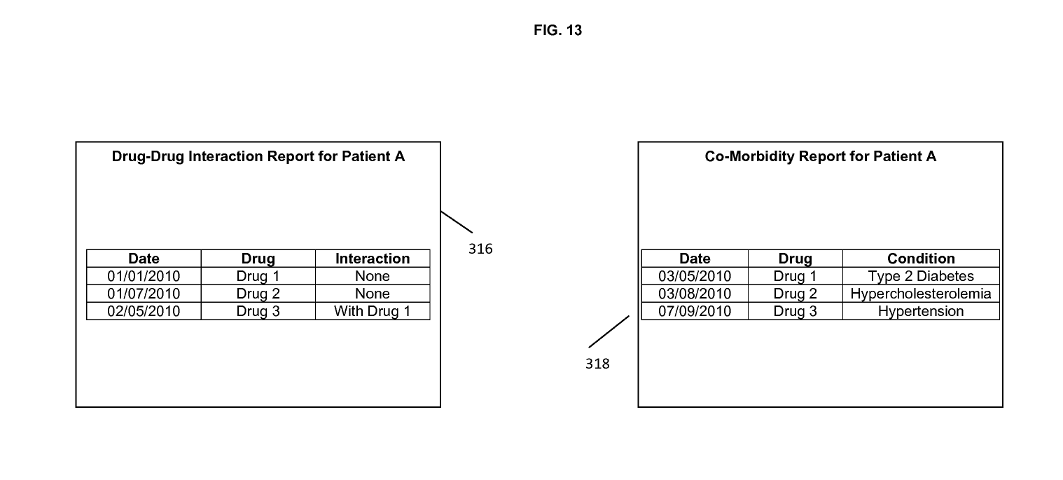

FIG. 13 is a diagram showing sample reports for the patient including a drug-drug interaction report and a co-morbidity report.

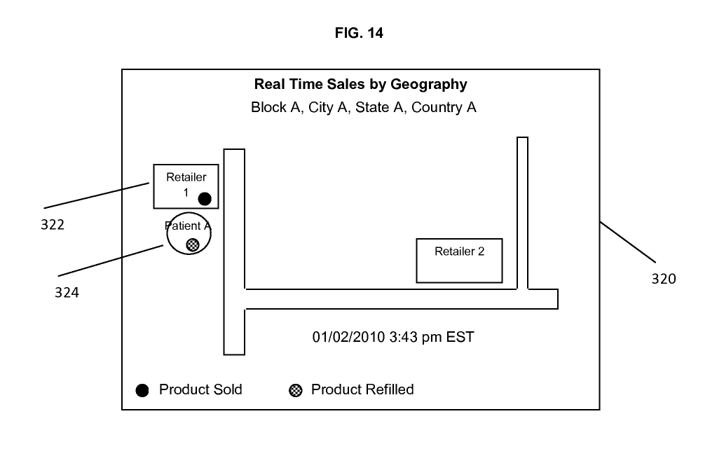

FIG. 14 is a diagram showing a sample visualization of real-time sales data across a specific geography.

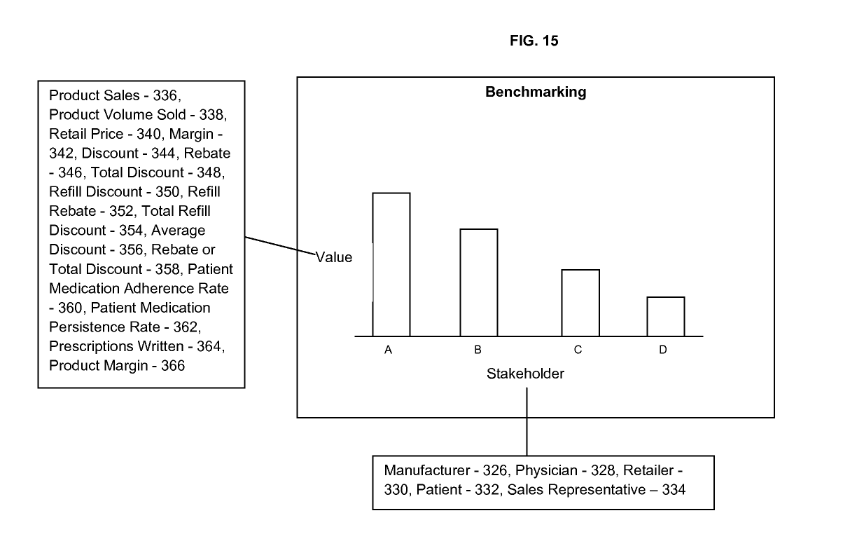

FIG. 15 is a diagram showing an example of how benchmarking between different stakeholders can be visualized.

In some examples of an approach to promoting pharmaceutical products across multiple health care stakeholders that we describe here, a unique identifier is mapped to attributes of a specific promotional campaign that, for example, involves a selected product or selected stakeholders or both. In some implementations, the unique identifier is made known to patients, for example, by physicians advising their patients of the unique identifier or by retailers of the selected pharmaceutical product in connection with dispensing the product to patients, or both.

Each patient can then communicate the identifier, for example, by mobile wireless communication devices, to destinations, such as a central pharmaceutical product promotion management system (which we sometimes call a promotion management system), that make use of the identifier. At the destinations, the communicated information can be recorded, interpreted, or analyzed or any combination of them, for example, by the promotion management system. The identifier can be used in connection with a wide variety of activities related to or in support of the product, the campaign, or the stakeholders, for example.

The promotion system, among other things, can carry out actionable attributes of the campaign. In some examples, the actionable attributes include, but are not limited, to customized communications, timed refill reminders, retailer rebates, or offering of patient discounts sent to relevant stakeholders. The goal of the actionable attributes is to aid pharmaceutical product awareness, affordability, or use, or combinations of those, among others. We use the phrase actionable attributes very broadly to include, for example, any action, step, or process, that is associated in any way with the produce, campaign, or stakeholders.

Active responses and passive data received from stakeholders in connection with the product or campaigns or both can be collected by the promotion system. The collected information, including information about the stakeholders and pharmaceutical product campaign information is then updated. Data, analytics, or reports based on the collected information, or combinations of two or more of them, are then produced. A wide variety of data and responses can be collected in a broad range of modes and used for an extensive array of purposes.

Among other things, at least some of the techniques that we describe below assist multiple health care stakeholders in improving, for example, the awareness, affordability, and use of pharmaceutical products by means of unique identifiers and a variety of communication devices. This is depicted in FIG. 1.

We use the term stakeholder in a broad sense to include, for example, any party that stands to be affected positively or negatively by programs that promote pharmaceutical products, for example, manufacturers, distributers, pharmacies, physicians, health care institutions, and patients.

These techniques enhance communication and data flow among the pharmaceutical manufacturer 2, the pharmacist 4, the physician 6, and the patient 8. Using the connected system that we describe here, product awareness can be improved, for example, by informing physicians, retailers, and patients about the safety and efficacy of a particular product, increasing affordability such as through point of purchase discounting, and improving the usage of these products through such programs as targeted medication adherence and education programs for individual stakeholders. A wide variety of other advantages and benefits can be derived from what we describe here.

The techniques that we describe here provide a product-centric and campaign-centric approach to product promotion and are usable on a wide variety of existing platforms without special work to ensure interoperability.

The techniques that we describe here allow for products to be tracked from the point of product recommendation by the physician, to the dispensing of the product by the pharmaceutical retailer, to the purchase of and use of the product by the patient. Customized communications and financial discounts for products can be based on product interactions to be sent to and received by the multiple involved stakeholders. Simple and complex analyses can be done of the tracking data and of the performance of the campaigns and used for a wide variety of purposes.

Here, we describe, among other things, a simple, inexpensive method for promoting pharmaceutical products across multiple health care stakeholders using wireless communication devices. Attributes of these techniques include, but are not limited to, product messaging, financial discounts or rebates and refill reminder prompts associated with the campaign ID.

Information and attributes regarding the pharmaceutical retailers are mapped to the retailer ID. Information and attributes regarding physicians are mapped to the physician ID.

Combinations of a campaign ID and a retailer ID or a campaign ID and a physician ID or any other combination of these and other IDs can be used to form the total ID for the purposes of this invention.

Total IDs can be made known to the patient by the physician and/or the retailer. The patient then can communicate the total ID through a wireless communication device.

This ID information communicated information from the user's wireless device can be recorded, interpreted, and analyzed by the system. The system carries out the actionable attributes of the campaign which include but are not limited to product messaging, financial discounts and/or rebates and refill reminder prompts to the relevant stakeholder or stakeholders to aid product awareness, affordability and use. The system may also be used to field ad hoc communications or payment transfers to any of the health care stakeholders involved.

Among others, a key objective of the system is to promote better multi-stakeholder pharmaceutical product engagement and improve product awareness, affordability and use for key stakeholders. An objective of the system is to integrate key stakeholders involved in patient care through a linked system relying on mobile phones 10 and computer systems 12. The key stakeholders include pharmaceutical manufacturers, physicians, retail pharmacists, and patients, and could include others. In any given action of the system, the system may execute a campaign or ad hoc communication to any single stakeholder, multiple stakeholders, or any combination of them.

As shown in FIG. 2, pharmaceutical manufacturers or other key stakeholders 20 involved in pharmaceutical product distribution, sales, and/or marketing provide information (campaign details 22) regarding a product 24 they wish to promote. Such products may include, for example, those which require a prescription 26 for dispensing or those that can be received without a prescription. In some implementations, information regarding such products may include all or any combination of two or more of the following attributes, among others:

Manufacturer or key stakeholder 28—The identity of the organization or other entity sponsoring the promotional campaign, for example, a product manufacturer, a distributor, or another key stakeholder, or a combination of them, whose objective is, for example, to promote pharmaceutical products for financial gain. The information associated with this attribute may include, for example, the company name, project manager name, location and/or contact information. For example, the name of the pharmaceutical company sponsoring the campaign as well as their geographic location may be associated with this attribute.

Brand Name 30—In the case of a pharmaceutical, the identity of the molecule as noted by its brand name within the geography where the campaign is being deployed.

Molecule Name 32—The identity of the molecule under scientific naming standards.

Dosage 34—The dosage of the brand that is being promoted by the campaign. For example a pharmaceutical product may be noted as having a dosage of 10 mg/pill.

Dosage frequency 36—The suggested number of times a pharmaceutical product is supposed to be taken over a given time period. For example, 1 pill twice daily.

Amount (units/pack) 38—The number of pills, tablets, capsules, volume of liquid or other dosage form included in each pack or unit sold of the promoted brand.

Retail Price 40—This will include the price of the drug sold in the retail channel. For example, Brand A may be sold by the retailer for $1.00; patient A would purchase Brand A from the retailer for $1.00. In case more than one price is listed for a given drug, the different prices will be noted and classified according to their method of categorization. For example, drugs sold via a chain of retail pharmacies may be at a lower cost than those sold through independent pharmacies. Such differences would be noted and accounted for in the system through categorization which would in turn be mapped to this attribute.

Rebate Amount 42—This will include a rebate amount of the retail price of the drug to be provided to the pharmacist, pharmacists, pharmacy, or pharmacy chain (all considered retailers in our discussion) whether noted as an absolute dollar amount or a percentage of the retail price. For example, in a simple form, if the retail price of the drug to the patient were $1.00, the rebate amount to the retailer for selling that product may be $0.10 or 10%. The rebate amount may also be variable and/or retailer-specific and depend on such factors as length of time a retailer has been involved in a campaign or series of campaigns, may be a fixed value that is provided on a per transaction basis or at a set time period, may be based on a volume of transactions, or may be based on any other criteria which modify a pharmacist margin. For example, the rebate amount may be based on a per transaction basis, on a series of related transactions, or on a series of non-related transactions. The rebate amount may therefore be modified dynamically depending on a variety of criteria that are variable in nature and whose characteristics are gleaned from analyzing trends from a collection of data collected over time.

Additional Product Details 44—This field may include information such as the number of competitors, additional product attributes, therapeutic class, disease treated, indications, historical data, safety and efficacy information, batch and lot numbers and other such information related to the product.

Discount Amount 46—This will include the amount of money that is to be deducted from the retail price for the benefit of the consumer, if applicable. The discount amount may be an absolute dollar amount or a percentage of the retail price. For example, if the retail price of a product is $1.00, the discount amount may be $0.25, allowing the customer to pay $0.75. The $0.25 would be provided to the pharmacist through the system to cover the discount. The discount amount may also be variable and/or patient-specific and depend on such factors as length of time a patient has been involved in a campaign or series of campaigns, may be a fixed value that is provided on a per transaction basis or at a set time period, may be based on a volume of transactions, or may be based on any other criteria that modifies the discount the patient receives. For example, the amount may be based on a per transaction basis, on a series of related transactions or on a series of non-related transactions. The discount amount may therefore be modified depending on a variety of criteria that are variable in nature and whose characteristics are gleaned from analyzing trends from a collection of data collected over time.

Total Discount 48—The total discount represents the sum of the discount made available to the consumer and rebate to be made available to the retailer. This amount may be calculated on a per transaction basis, by a series of transactions, over a fixed or variable time period, or any other criteria as defined by the parameters associated to the discount amount and/or rebate amount. It is the amount or forms part of the total amount that the system will ultimately transfer to the retailer.

Refill Date (from initial purchase) 50—This is used to identify when the consumer should be prompted to refill the medication (we sometimes use the term medication interchangeably with pharmaceutical product). For example, if initially the patient purchased a pharmaceutical product with 10 pills included in each pack (the Amount) with a dosage frequency of 1 pill/day, the system will remind the patient to purchase that drug before, on, or after the 10th day. The system may also send daily reminders or intermittent reminders depending on the objectives of the particular promotional campaign.

Refill Discount 52—This is used to determine the discount if the patient refills. This may be fixed or variable for the product, the retailer, or the patient. The refill discount may depend on a variety of criteria that are variable and whose characteristics are gleaned from understanding trends from a collection of data from consumer interactions and other factors including but not limited to performance with a single campaign or multiple campaigns over time. For example, a patient who refills on time all the time may receive a greater discount that a patient who refills less frequently.

Refill Rebate 54—This is used to determine the rebate amount to provide to the retailer if a refill is made. This may be fixed or variable for the product, the retailer, or the patient. It may depend on a variety of criteria that are variable in nature and whose characteristics are gleaned from understanding trends from a collection of data from patient and retailer interactions and other factors including but not limited to performance with a single campaign or multiple campaigns over time.

Refill Total Discount 56—The total discount represents the sum of the refill discount to be made available to the consumer and the refill rebate to be made available to the retailer. This amount may be calculated on a per transaction basis, by a series of transactions, over a fixed or variable time period or any other such criteria as defined by the parameters associated to the discount amount and/or rebate amount. It is the amount or forms part of the total amount that the system will ultimately transfer to the retailer.

Geography—Identifies the geography of the campaign. Campaigns may be limited to a particular geography. Campaigns may differ based on the geography they are fielded in. For example, two different campaigns for the same product may exist if one is being run in a geography where pharmaceutical manufacturer market share is high and a different campaign with different attributes may be run in a geography where pharmaceutical market share is low.

Campaign Messaging 58—This includes any information that needs to be communicated (or would be desirable or appropriate to communicate) to the relevant stakeholders who are enrolled in or involved in some way with a campaign. For example, a patient enrolled in a campaign may receive a communication (we sometimes use the term communication interchangeably with message) that Brand A also helps improve Condition X or that Pharmacy A is located near the patient. For example, a retailer may receive a message stating that the Total Discount has been transferred to their bank account. For example, a physician may receive a message that the patient filled the prescription of Brand A at Pharmacy A. These messages may be fixed or variable depending on the data collected and analyzed by the system. The communications may differ based on the stakeholder group or specific individual within such group. Furthermore, the sending of these messages by the system may be timed to other events or may be sent independently of such events.

Campaign Start Date and End Date 60—Dates entered here would limit the duration of the campaign. For example, if a campaign were to be run for a single month, dates to this effect could be entered here and once the month was over, the campaign would be terminated, modified, or transferred to another campaign depending on the customizations associated to this attribute.

Once this information is collected it is stored in the system 62. The system assigns a unique identifier (a campaign ID 64) to each campaign. Multiple campaign IDs can be combined to form a single parent campaign ID. Additionally, alphabetical, numerical or alphanumeric characters that represent the attributes may be used. For example, an alphanumeric string may be assigned to the campaign sponsor.

The campaign ID can be a number, alphabetic, or alphanumeric identifier. The identifier can be generated randomly, non-randomly, or be generated by hashing one of several attributes. In some embodiments, the campaign ID or the attributes linked to the campaign ID may also be mapped to a QR or Quick Response code, a type of two dimensional code that is easily readable by a variety of devices including mobile devices. In summary, the Campaign ID is used to represent the attributes of a product in a simple form. Therefore, if a stakeholder enrolls in a campaign then the system knows how to treat and classify that stakeholder in terms of communications and/or monetary transfers.

As shown in FIG. 3, in some implementations, a retailer 66 refers to a single pharmacist, several pharmacists, a group of pharmacists, a pharmacy, a chain of pharmacies, or any combination of two or more of them or other retailers of pharmaceuticals. We use the term retailers broadly to include any stakeholder who sells or dispenses pharmaceutical products whether with a prescription or without a prescription to patients or consumers.

Retailers are enrolled in the system using in-person signup, online signup, signup in written form or signup via mobile or other mode of communication. Several attributes associated with the retailers are collected as retailer details 68. Information regarding the retailers may include all or any combination of two or more of the following elements and others:

Company Name 70—This refers to the name of the company that owns and/or operates the retail operation.

Retailer Name 72—This refers to the name of the retail operation.

Mobile Phone Number (Primary Registrant) 74—This is the primary mobile phone number for the retailer account. For example, this may be the mobile phone number that belongs to the owner of a location. In the case that a primary registrant uses more than one mobile phone number, the additional phone numbers will be associated to the primary mobile phone number.

Mobile Phone Numbers (Secondary Registrants) 76—This refers to the secondary mobile phone numbers which may belong to employees, associates or other stakeholders involved in the operations of that retail location. For example, while the primary registrant may be the retail shop owner, each of the 5 employees in the shop may have their mobile phone numbers registered as well. If applicable, this will determine the level of communication and financial incentives they receive from the system regarding the transactions that are processed. For example, a senior employee may receive 20% of the total discount, whereas a junior employee may receive 10% of the total discount. In some instances, secondary registrants may be linked to primary registrants for the purposes of simplifying transactions and communications. In the case that a secondary registrant uses more than one mobile phone number, the additional phone numbers will be associated to the primary mobile phone number for the secondary registrant

Address 78—This is the address of the retail location. In the case of multiple retail locations, this entry would include multiple addresses corresponding to each location. The address may include but is not limited to information such as unit number, street address, city, state/province, country, zip code or other identifiers.

Pharmacist or Other Stakeholder Names 80—This entry includes the full name of the primary registrant and secondary registrants and are each linked to a corresponding mobile phone number or numbers if applicable.

Volume 82—This entry may include the volume of promoted brand products sold in a given time frame whether historical, current or projected.

Additional Information 84—This may include but is not limited to sales information, location information, tax number, license/registration number or qualitative information on the pharmacist or pharmacists. It may also include other contact information including but not limited to an email address or a phone number.

Bank Details 86—Information associated with this element may include but is not limited to banking information to transfer the total discount to the retailer. For example, this may include information to process an electronic deposit, information on a peer to peer money transfer protocol, address information to send deposit checks, or information to transfer payments directly to mobile phones. It would therefore include the necessary account details and the method of funds transfer enabling the system to transfer money as needed. Examples of such protocols are known. Information associated with this attribute would need to be sufficient to enable the transfer of monies whether through electronic or non-electronic means to the retailer.

Sales Representative or Sales Representatives Information 88—This entry would include the names, departments, contact information, address information and other additional details of any of the sales representatives or account managers who are responsible for that retailer. The sales representative may work for the pharmaceutical manufacturer who has sponsored the campaign or for a contract sales organization contracted by the pharmaceutical manufacturer to promote the product or for any other organization that benefits financially from promoting a product. Furthermore, such an entry may include historical data regarding the sales representative's historical sales, their goals and how they are performing against those goals. For example, the system would note that Sales Representative A is responsible for educating Retailer A about Brand A.

Alternately, this information may be stored separately in a database with its own unique identifier (a sales representative ID) and exist independently or be associated with one or more physician IDs, retailer IDs, or campaign IDs or any combination of them. In the case of a separate sales representative ID, some or all of the earlier mentioned attributes could be associated with the sales representative ID. Such categorization would also enable communication to and from sales representatives through the communication gateway and may involve financial incentives such as bonus payments to be delivered through the banking gateway. In this sense, the sales representatives can, in some implementations, be considered another class of stakeholder.

For example, if information regarding sales representative A is located in the database, the pharmaceutical manufacturer may want to communicate with the sales representative that he or she has accomplished sales targets for the month. The manufacturer could send an ad hoc or system automated message to the sales representative informing him that he achieved his target and that a $1.00 sales bonus will be added to his account. The communication gateway and the banking gateway provided by the system would enable such transactions.

The accumulated retailer details are stored in the system 90 and the system creates a retailer ID 92 which can be a number, alphabetic or alphanumeric identifier. The identifier can be generated randomly, non-randomly or be generated by hashing one of several attributes. In some embodiments, the retailer ID or the attributes linked to the retailer ID may also be mapped to a QR or Quick Response code, a type of two dimensional code that is easily readable by a variety of devices including mobile devices. Additionally, alphabetical, numerical or alphanumeric characters that represent the attributes may be used. In summary, the Retailer ID is used to associate a retailer to attributes that are specific to such stakeholder.

Referring to FIG. 4, physician 94 refers to a single physician, several physicians, a group of physicians, a clinic, a chain of clinics, a hospital, a geographic region containing several physicians or any combination thereof. More broadly, when we use the term physician we include, for example, any stakeholder who can prescribe or recommend pharmaceutical products, whether or not a prescription is required, to patients or consumers.

Physicians are enrolled in the system using in-person signup, online signup, signup in writing or signup using mobile or other mode of communication. Several attributes associated to the physicians are collected. Information regarding the physicians may include, for example, all or any combination of two or more of the following elements, collectively known as physician attributes 96, and others:

Company Name 98—This refers to the name of the company that owns or operates the physician's practice or operations. For example, if the physician's clinic is owned by a company (for tax or other reasons), it would be listed here.

Office Name 100—This refers to the name of the physician's office if applicable. For example, if the physician practices in a hospital, the name of the hospital would be listed here.

Mobile Phone Number (Primary Registrant) 102—This is the primary mobile phone number for the account. For example, this may be the mobile phone number that belongs to the physician. In the case that a primary registrant uses more than one mobile phone number, the additional phone numbers will be associated to the primary mobile phone number.

Mobile Phone Numbers (Secondary Registrants) 104—This refers to the secondary mobile phone numbers which may belong to employees, associates or other stakeholders involved in that physician's practice or operation. For example, while the primary registrant may be the lead physician, the nurses may be entered as secondary registrants. If applicable, this will determine the level of communication they receive from the system regarding the pharmaceutical product or the stakeholders involved. In some instances, secondary registrants may be linked to primary registrants for the purposes of simplifying communications. In the case that a secondary registrant uses more than one mobile phone number, the additional phone numbers will be associated to the primary mobile phone number of the secondary registrant.

Address 106—This is the address of the physician's location. In the case of multiple locations, this entry would include multiple addresses corresponding to each location. The address may include but is not limited to information such as unit number, street address, city, state/province, country, zip code or other identifiers.

Physician or Other Stakeholders Names 108—This entry includes the full name of the primary registrant and secondary registrants which are each linked to a corresponding mobile phone number or numbers if applicable.

Sales Representative or Sales Representatives Information 110—This entry would include any of the names, departments, contact information, address information and other additional details of any of the sales representatives or account managers who are responsible for or assigned to or associated with promotion of the produce to that physician, practice, clinic, hospital and/or regional account. The sales representative may work for the pharmaceutical manufacturer who has sponsored the campaign or for a contract sales organization contracted by the pharmaceutical manufacturer to promote the product or for any other organization that benefits financially from promoting a product. Furthermore, such an entry may include historical data regarding the sales representative's historical sales, their goals and how they are performing against those goals. For example, the system would note that Sales Representative A is responsible for educating Physician A about Brand A.

Alternately, this information may be housed separately in a database with its own unique identifier and exist independently or be associated with one or more physician IDs, retailer IDs, and/or campaign IDs. In the case of such a separate sales representative ID, the aforementioned attributes would be associated to the sales representative ID. Such categorization would also enable communication to and from sales representatives through the communication gateway and may involve financial incentives such as bonus payments to be delivered through the banking gateway. In this sense, such sales representatives could be considered a separate class of stakeholder.

Additional Information 112—Information in this category may include but is not limited to location information, additional contact information such as an office number, prescribing habits, or other qualitative information on the physician or other associated stakeholders. It may also include other contact information including but not limited to an email address or a phone number.

The accumulated physician attributes are stored in the system 114. The system then generates a physician ID 116 which can be a number, alphabetic or alphanumeric identifier. The identifier can be generated randomly, non-randomly or be generated by hashing one of several attributes. In some embodiments, the physician ID or the attributes linked to the physician ID may also be mapped to a QR or Quick Response code, a type of two dimensional code that is easily readable by a variety of devices including mobile devices. Additionally, alphabetical, numerical or alphanumeric characters that represent the attributes may be used. In summary, the Physician ID is used to associate a physician with attributes that are specific to such stakeholder.

Referring to FIG. 5, the steps have shown the elements involved in the creation and use of a campaign ID 120, a retailer ID 118 and a physician ID 122. The campaign ID 120 is a central unifying identifier for a product campaign and the attributes associated with it.

In some implementations, the system combines a campaign ID with a retailer ID to produce a total ID 124. The creation of the total ID may be random, non-random or a combination of the two. The total ID is then made known to the retailer either in person, verbally, in written form, in electronic form, through a mobile phone or through any other mode of communication or through multiple such methods.

When a patient 126 requests a product from the retailer 128 for which such a total ID exists, the retailer will provide the patient with the total ID. The total ID may be provided to the patient in person either verbally, in written form, in electronic form or in any combination of two or more of them. In some examples, the campaign ID may be provided to the patient and he or she may be provided a retailer ID separately. By combining these two elements a total ID will be formed. This represents another method of creating a total ID.

In some cases, when a patient is advised to take a pharmaceutical product whether through prescription or through simple recommendation if no prescription is required and a total ID exists for that product, the physician 130 will provide the total ID to the patient. The Total ID may be provided to the patient verbally, in written form and/or in electronic form or any combination of them. In the case of the physician, the total ID may or may not include the physician ID and the campaign ID depending on the amount of information linked to the physician ID. In another form, the campaign ID may be provided to the patient and he or she may be provided a physician ID separately. By combining these two elements a total ID can be formed. This represents another method of creating a total ID.

Total IDs or parts of them may also be printed directly onto or labeled onto the packaging of the pharmaceutical product. For example, a package of Brand A destined for retailers located in Geography A may be labeled with a specific total ID which may or may not include the retailer ID. This way customization of the campaigns can take place and the communication method of total IDs to retailers and then to patients can be more direct.

Total IDs may be specific to certain groups. For example, a specific total ID may be created and delivered only to a certain geography or to a certain physician type or both. In this way, the campaigns can be customized. Groupings associated with total IDs include but are not limited to:

Retailer Group—Campaigns may be fielded to all retailers in a given geography or different campaigns may be fielded to different categories of retailers within a geography as defined by a collection of data on such retailers as collected and analyzed by the system.

Physician Group—Campaigns may be fielded to all physicians in a given geography or different campaigns may be fielded to different categories of physicians in the geography as defined by a collection of data on such physicians as collected and analyzed by the system.

Patient Group—Campaigns may be fielded to all patients in a given geography or different campaigns may be fielded to different categories of patients in a given geography as defined by a collection of data on such patients as collected and analyzed by the system.

Referring to FIG. 6, in some implementations, the patient 128 uses his or her mobile phone 130 to send in the total ID 132 to a communication receiver using, for example, a short messaging service (SMS) also known as a text message or any other form of communication using one's mobile phone. For example, this could involve sending a string of alphanumeric characters A123B456C to a phone number long code or short code such as 212-555-1234 or 1234. Upon receipt of the total ID from the communication receiver 146 by the application 148, the mobile phone number 134 of the patient is logged along with the date 136, time 138, and time zone of the communication 140, and if discernable, the location of the area code 142 as accomplished by reverse lookup or other means. Additional details 144 regarding the mobile phone number or mobile phone used may be gathered at this time or later. Together with the total ID, this information forms an entry in the patient database 150.

Each time a total ID is sent to the system it is associated with that patient entry within the database enabling multiple products and/or refills of the same product to be associated to that patient. In the case where the patient has more than one mobile phone number, multiple mobile phone numbers can be linked to the same patient account. The system has the ability to prompt the user to register their phone number if not already registered in the system, or if the user is registered in the system with a different mobile phone number, it will ask to link it to other registered numbers. The system also has the ability to assign the patient a user identification—an alphabetic, numeric or alphanumeric unique identifier. This identifier may help associate a patient with his account if the system is unable to link the mobile phone numbers of the users. In communicating with such a patient holding multiple mobile phone numbers a single or multiple phone numbers may be used to communicate with said patient and responses may be received from a single or multiple phone numbers associated with said patient. The patient database contains all of these kinds of information associated with the patient, and can include a wide variety of other information.

In some implementations, the retailer or physician may use his or her mobile phone to text the total ID to the system on behalf of the patient. If this occurs, the retailer or physician will text a phone number long code or short code with the Total ID and the patient's mobile phone number. The patient's mobile phone number may be located before or after the total ID. In some cases, the patient's mobile phone number may be spliced in the total ID. Upon receipt of the total ID and a patient's mobile phone number, the system will recognize that a retailer or physician is registering a patient on his behalf. The system may also check the incoming mobile phone number (physician or retailer) with the information already stored and associated with the stakeholder profiles. The system may also check if the patient's mobile phone number is already registered in the system and link the accounts.

Once the total ID is received and the initial data is collected, the system can easily track contact with the key stakeholders. Receipt of a total ID causes the application to map the received identifier to the campaign, retailer, and or physician for which it was generated and link it to the patient's account. This mapping can be done via one or more of multiple means including but not limited to codebooks which store each unique identifier with its associated attributes. Other means for mapping may include algorithms that could deduce this information from the total IDs themselves as attributes regarding campaigns, retailers, and/or physicians would have been encoded in the unique identifiers at the point of identifier generation. There are many algorithms for achieving this, several of which are noted in the literature such as hash functions and fingerprinting algorithms. Therefore, by mapping the received identifiers with linked attributes, the system is able to link in near real time product promotional campaigns to the retailers, physicians and patients who are involved in such campaigns and therefore enable immediate action on the basis of their interactions.

Referring to FIG. 7, in some implementations, the system includes three primary functional modules that (along with other modules) can be implemented in software, hardware, or a combination of them on a wide variety of platforms. The three primary modules are a payment gateway 152, a communication gateway 154, an application 156, and a set of databases 158 that store collected information.

In some instances, the databases include but are not limited to a Campaign Database 160, a Patient Database 162, a Retailer Database 164, and a Physician Database 166. The databases may be held separately within the system or may be consolidated into a single database or multiple databases as necessary. Other databases can also be part of the system.

In some examples, the banking gateway enables the transfer of funds to and among stakeholders and the host of the system. The sender and receiver of such funds require bank information to be accessible by the system whether such information is held internally or externally. Transfers of funds between senders and receivers can take place using a variety of mechanisms including but not limited to electronic funds transfers, mobile banking, check, cash, money order, or other mechanism of financial transfer covered by the prior art. For example, a pharmaceutical manufacturer may transfer a rebate to a retailer from its bank account to the retailer's bank account or through an intermediary. Furthermore, the system may post funds to a stakeholder's account, but not make the physical financial transfer unless a future event is executed or a certain time period has elapsed. For example, a retailer who sells a promoted product to a patient and is owed a total discount of $0.30 may be paid such amount instantly or that $0.30 may be posted to their online account but may not be transferred to his or her account until it reaches $10.00. Therefore, the system is able to calculate, store and transfer payments based on criteria defined through system controls and to make the payments conditional. Online and mobile payment systems are known.

In some cases, the communication gateway 154 enables the transfer of messages to and among stakeholders. The communication gateway relies on two points: a sender identification and a receiver identification. Mobile phones are used primarily to accomplish such tasks. In some instances, communications may be done in person, in written form, in electronic form or through any other mode of communication.

Referring to FIG. 8, as noted previously, information about the product campaign, the patient, the retailer, and/or the physician, among other things, can be collected and stored in the system either as a single database, multiple databases, distributed, databased, or any combination of those 168. Once a total ID is received, the system interprets the identifier and maps it back to the attributes of that campaign, the retailer, the physician and/or the patient depending on the information received in a step known as campaign initiation 170. Once received, the system will execute the campaign 172 according to the attributes for that campaign and may also modify certain attributes or treat campaigns in a variety of ways.

For example, once a campaign for Brand A is executed, a consumer may receive a message on his mobile device 174 stating that he received the product for $0.25 instead of $0.60 and that Brand A was shown to be effective in reducing the symptoms of disease X by Y percent, or similar educational information. The pharmacist may receive a notification that the $0.35 discount plus a rebate of $0.10 has been transferred to his bank account. At this time, the system may, depending on predefined criteria, transfer funds to cover the total discount of $0.45 to the pharmacist's bank account. The physician may receive a notification that Patient A filled his prescription at Retailer X.

Any responses to closed or open ended questions or queries that are sent to any of the campaign messaging protocols are received by a communication gateway 176 and the system updates the data 178 in the databases.

Upon campaign execution, the relevant financial amounts can be transferred through the payment gateway 180 to the stakeholder's bank account or similar method of funds receipt 182. The system acts to monitor the stakeholders throughout their enrollment in the campaign. As such, the system may note that a patient has not refilled his prescription at a retailer in a given time period. The system would note this, for example, because no new total ID for that product was received within the duration of the Refill Date as defined in the Campaign attributes from the time and date of the receipt of the original total ID. In such a case, the system would prompt the user to refill his product, and such a reminder may include simple communications, or financial and non-financial incentives.

The system or in certain cases, operators of the system (we sometimes refer to the operators as the host or hosts of the system), monitor incoming and outgoing data and are able to develop rules which serve to enhance the performance of campaigns through multi-stakeholder approaches. The system or operators of the system are able to use all the databases, single databases or any combination of them to optimize such campaigns.

For example, the system may tie together multiple data sets and create a communication targeted to a patient that may state “Thank you for purchasing Brand A from Retailer A. Physician A encourages you to take your dose 3× daily”. In some examples, this information would be gathered by following the patient from the time when he or she is recommended the medication by the physician and given a total ID to the time when the patient sends in another total ID when the prescription is filled at the retailer. The system therefore has all the necessary attributes to provide a customized communication to the patient. Furthermore, the system has the ability to track the patient going forward and initiate campaigns even if a total ID is not received as long as the stakeholder is already in the system.

Referring to FIG. 9, in some implementations, the system also allows for ad hoc messaging and communications and/or payments 184 with stakeholders to occur. Furthermore, information about stakeholders can be sorted by a variety of variables as stored in the databases 186 that were collected initially and are continuously updated. Stakeholders can then field a communication and/or payment 188 to an end user, for example, to the end user's mobile device 190 through the communication gateway 192 in the case of a communication or to their account 196 through the payment gateway 194 in the case of a payment transfer.

For example, a pharmaceutical manufacturer may wish to notify retailers and physicians that a new drug has been launched in Region X (a geography). This message would then be fielded to all the retailers and physicians in Region X. In another example, a manufacturer may wish to conduct market research and retailers may be asked if they stock a brand. The retailer would respond using his or her mobile phone and the responses would then be used to update the databases. In another example, all retailers who carry a product may be notified that the product has been recalled. In another example, a payment may be transferred to all retailers on behalf of a pharmaceutical manufacturer for a one-time rebate.

The system would then either simply log the responses or categorize individuals or groups according to their responses 198 and enroll them in new campaigns or provide further messaging content.

Ad hoc messaging may be delivered in person, in written form, in electronic form, on the phone, or through any other mode of communication. Ad hoc payments processed by the payment gateway can take place via a variety of mechanisms including but not limited to electronic funds transfers, mobile banking, check, cash, money order, or other mechanism of financial transfer.

Referring to FIG. 10, in some instances, the system collects a vast amount of data and constantly updates the data based on passive and active responses from multiple stakeholders. As such, the system is able to request and analyze such data 200 from the databases 202 and display it in the form of metrics, reports or other visualization tools 204. For example, the system may know that Physician A recommended Patient A to take Brand X and Patient A received Brand X from Pharmacy A located in Region 1 at Time X. In this case, the system could follow a patient's history across multiple stakeholders and in the case where regional information were available, could be plotted on a map.

A series of distinct (e.g., independent) transactions or sequences, or behavioral patterns, for one or more patients, such as those noted in the example, may be collected and analyzed according to a series of variables. Furthermore, the system may calculate and display data on an aggregate basis. For example, the system could calculate based on the information collected that 40% of patients in Region 1 refill their medication on time, or the average discount for Brand X is $0.20, or there are 10,000 patients registered in a campaign.

The data and analytics produced may be viewed using any device capable of displaying such information or may be produced and disseminated to the relevant stakeholders in written form. Additionally, stakeholders may use their mobile devices to access information on the system. For example, a physician may text or SMS a registered patient's mobile phone number to the system and receive a report on their product use history including which medications they are using and their adherence and persistence to therapy rates. In another example, a pharmacist may want to understand how many of his patients are refilling their medications on time which could be provided by the system. In another example, a pharmacist could check their account balance or transaction history by communicating to the system using a mobile device. Furthermore, information residing in the system may be able to be accessed via computer in which case more detailed information may be available.

There are many possible reports that can be generated from the data some of which include but are not limited to:

As depicted in FIG. 11, the system collects a variety of information and has the ability to display this data in various forms. Data can be filtered by a variety of attributes that are collected.

In some implementations, various graphs and charts 206 could be formed to visualize this information. Attributes 208 stored in the system can be used to filter the type of information displayed by the system. Filters may include a single attribute or multiple attributes. Filters may also exclude certain attributes. Attributes collected that can be used as filters (either individually or in combinations of two or more of them) include but are not limited to:

Manufacturer—210, Brand—212, Molecule—214, Dosage—216, Dosage Frequency—218, Amount—220, Retail Price—222, Rebate Amount—224, Total Discount—226, Refill Date—228, Refill Discount—230, Refill Rebate—232, Refill Total Discount—234, Geography—236, Patient Group—238, Physician Group—240, Retailer Group—242, Campaign Start Date—244, Campaign End Date—246, Company Name—248, Retailer Name—250, Mobile Phone Number—252, Pharmacist—254, Physician—256, Sales Representative—258, Office Name—260, Additional Information Associated to Campaign—262, Retailer—264, Physician—266, Sales Representative—268, Date—270, Time—272, or Time Period—274

In some cases, filters can limit the variables that will be plotted on the graph or other visualization. For example, if a stakeholder wishes to know the sales volume of a single retailer over time, one would select retailer as the filter and chose Product Volume Sold and Time as the y and x variables, respectively. Variables are usually quantitative in nature which ascribe to this method of visualization. Variables include but are not limited to:

Product Sales—276, Product Volume Sold—278, Date—280, Time—282, Retail Price—284, Margin—286, Discount—288, Rebate—290, Total Discount—292, Refill Discount—294, Refill Rebate—296, Total Refill Discount—298, Average Discount—300, Rebate or Total Discount—302, Patient Medication Adherence Rate—304, Patient Medication Persistence Rate—306, Prescriptions Written—308, Product Margin—310

In some instances, variables may be used as filters. For example, one may wish to understand the average discount over time within a highly adherent patient population with an adherence rate greater than 80%.

As depicted in FIG. 12, in some implementations, it is possible to generate detailed patient reports as their drug purchase history is recorded. An adherence report 312 for a single patient or a set of patients could be generated. The system knows when a patient first fills their medication, knows the dosage frequency and the amount and therefore knows the refill date. Therefore, an adherence rate can be calculated. This is one example of a patient-specific report. Similarly, a refill rate 314 could be calculated from the same information and this may be able to indicate what long term persistence to the medication may be.

As depicted in FIG. 13, using the system data, it is possible to generate custom reports for each patient which could display if there were any drug-drug interactions 316. As the system logs drug purchases it is able to create a linked patient record that will then allow for rules-based detection of drug-drug interactions. For example, if a patient takes Drug 1 and it conflicts with Drug 3, the system could push a communication to the patient, the retailer and/or the physician noting the drug-drug interaction and to stop taking the medication immediately. Furthermore, the system could also document the diseases that each patient has and generate a co-morbidity report 318. Because the system knows the drug and therefore the indications of that drug, it is able to create a history for the patient that documents their co-morbidities.

As data is collected in the system in near real-time, it is possible to display this data in an active format. As depicted in FIG. 14, the system could display an active map 320 where retailers 322, physicians, patients 324, sales representatives or other stakeholders registered in the system are represented on the map. As the system knows the location of each of the stakeholders due to stored address information or has proxy measures of obtaining their location such as reverse area code lookup or assuming a patient's approximate location based on the location of the retailer they just purchased from, it is possible to plot locations on a map. It is then possible to visualize exactly when a sale is made and what type of sale is made. For example, one could view that Retailer 1 sold a product to Patient A on Jan. 2, 2010 at 3:43 pm EST.

As the system collects transaction and behavioral data regarding multiple stakeholders, it is possible to compare across stakeholders. For example, one could compare the sales of the same molecule in a certain geography between Manufacturer A and its competitor Manufacturer B. One could also compare the number of prescriptions for a certain branded medication written by Physician A versus Physician B. One could also measure how one Sales Representative performs relative to another Sales Representative as measured by product sales. Many such comparisons are possible. Stakeholders include but are not limited to:

Manufacturer —326, Physician —328, Retailer —330, Patient —332, Sales Representative—334

Variables that can be mapped include but are not limited to:

Product Sales—336, Product Volume Sold—338, Retail Price—340, Margin—342, Discount—344, Rebate—346, Total Discount—348, Refill Discount—350, Refill Rebate—352, Total Refill Discount—354, Average Discount—356, Rebate or Total Discount—358, Patient Medication Adherence Rate—360, Patient Medication Persistence Rate—362, Prescriptions Written—364, Product Margin—366

These variables could be filtered by date and time or any other set of filter types.

We use the term campaign in the broadest sense to refer to, for example, a group or series of promotional elements of any kind or nature. The elements could include, for example, a combination one or more of rebates, discounts and messages that are designed to promote a pharmaceutical product.

We use the term product or (sometimes interchangeably) pharmaceutical product in the broadest sense to refer, for example, to any drug, medication, or other product (or service) used for health or wellness purposes.

We use the term stakeholder in the broadest sense to include, for example, any party that stands to be affected positively or negatively or both by any campaign or other program that promotes products such as pharmaceutical products, for example, manufacturers, distributers, pharmacies, physicians, health care institutions, and patients.

We use the term unique to refer to the nature of the identifier in that it is different from other identifiers. A unique identifier, for example, refers to any unique number, alphabetic, or alphanumeric string of characters or visual representation (such as a quick response code. Two unique identifiers, for example, A42342 and B23498, may or may not refer to the same set of attributes that they are linked to or associated with but the representations of that set of attributes will be different for the two unique identifiers.

We use the term actionable in the broadest sense to refer, for example, to any activity, event, step, or transaction, or any combination of them, including an executable command by the system that performs a certain transactional function. Messages, communications, rebates, and discount transfers are examples of actionable commands.

We use the term ad hoc in the broadest sense, with reference to messages, rebates, and discounts to mean, for example, not pre-programmed to be part of the actionable attributes of the campaign. Ad hoc communications or payment transfers, for example, can be initiated without being pre-programmed into the campaign. For example, a patient may already be enrolled in a campaign for Product A and will be receiving communications that are associated with that campaign, but the system can use an ad hoc action to notify the patient about a new product that may be of interest and was not originally part of the campaign attributes.

We use the term enrolled in its broadest sense to refer to m, for example, registration such as stakeholder registration. Once a stakeholder is registered in the system for the first time by receipt of a total ID or other method of signup, the stakeholder is considered to be enrolled into the system, as a record has already been created for the stakeholder.

We use the term geography in its broadest sense to refer to any arrangement or location of places. For example, a city block may be considered a geography, similarly, an entire country may be referred to as a geography.

The concepts, techniques, and devices discussed above can be implemented in a wide variety of ways and on a wide variety of computational, networking, and mobile platforms. Any computing device and any mobile device may be used for interaction of a stakeholder with the system or with other stakeholders, for storing information, and for performing actionable elements.

Information used in the system can be held in any kind of storage device at one or more locations. The storage devices can be associated with computers or mobile devices.

The computing devices can be any form of digital computer, such as laptops, desktops, workstations, personal digital assistants, servers, blade servers, mainframes, and other appropriate computers. The mobile device can be, for example, any kind of personal digital assistants, cellular telephones, smartphones, and other similar devices.

The computing devices may each include a processor, memory, a storage device, a high-speed interface connecting to memory and high-speed expansion ports, and a low speed interface connecting to low speed bus and storage device. The processor can process instructions for execution within the computing device, including instructions stored in the memory or on the storage device to display graphical information for a GUI on an external input/output device.

The computing devices may be implemented as a standard server or a group of such servers.

Each device may communicate wirelessly through a communication interface under various modes or protocols, such as GSM voice calls, SMS, EMS, or MMS messaging, CDMA, TDMA, PDC, WCDMA, CDMA2000, or GPRS, among others. Such communication may occur, for example, through a radio-frequency transceiver. In addition, short-range communication may occur, such as using a Bluetooth, WiFi, or other such transceiver. In addition, a GPS (Global Positioning System) receiver module may provide additional navigation- and location-related wireless data to each device, which may be used as appropriate by applications running on device.

Each device may also communicate audibly using audio codec, which may receive spoken information from a user and convert it to usable digital information. The audio codec may likewise generate audible sound for a user, such as through a speaker, e.g., in a handset of device. Such sound may include sound from voice telephone calls, may include recorded sound (e.g., voice messages, music files, and so forth) and may also include sound generated by applications operating on device.

The mobile device may be implemented in different form, for example, as a cellular telephone, a smartphone, a personal digital assistant, or a tablet computer.

Various implementations can include one or more programs or applications or apps that are executable and/or interpretable. These computer programs (also known as programs, software, software applications or code) include machine instructions for a programmable processor, and can be implemented in a high-level procedural and/or object-oriented programming language, and/or in assembly/machine language. The terms “machine-readable medium” “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback). Input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Other implementations are within the scope of the following claims.

1. A computer-implemented method comprising
maintaining an association between a promotional campaign for a pharmaceutical product, and an identifier that is unique with respect to at least one of the campaign, the product, or a stakeholder associated with the product, and
storing, in association with the unique identifier, information about at least one of the following: the campaign, the product, the stakeholder, or activities of the stakeholder with respect to the product.

2. The method of claim 1 in which the stakeholder comprises at least one of an end user of the product, a physician who prescribes or recommends the product, a manufacturer of the product, or a retailer of the product.

3. The method of claim 1 in which the unique identifier is provided to a stakeholder who is an end user of the product.

4. The method of claim 3 in which the unique identifier is provided to the end user by the end user's physician or by a retailer that serves the end user or both.

5. The method of claim 1 in which information about the activities of the stakeholder is provided from a mobile device of the stakeholder.

6. The method of claim 1 in which information is stored, in association with the unique identifier, about activities of multiple stakeholders with respect to the product.

7. The method of claim 1 in which the unique identifier is associated with attributes of the associated campaign.

8. The method of claim 1 comprising analyzing the stored information with respect to the campaign.

9. The method of claim 8 comprising analyzing the stored information with respect to at least one other campaign.

10. The method of claim 1 comprising carrying out actionable attributes of the campaign.

11. The method of claim 10 in which the actionable attributes comprise at least one of customized communications, timed refill reminders, retailer rebates, or end user discounts.

12. The method of claim 1 comprising providing reports based on the stored information.

13. The method of claim 1 in which the information comprises responses of the stakeholder.

14. The method of claim 1 comprising sending messages to the stakeholder.

15. The method of claim 14 in which the messages comprise information including at least one of safety and efficacy of the product, affordability features of the product, discounts, promotions, coupons, rebates, medication adherence, education programs, and drug interactions.

16. The method of claim 14 in which the messages comprise customized communications or discounts that are based on relationships of the product to other products.

17. The method of claim 1 comprising tracking a sequence of activities with respect to the product.

18. The method of claim 17 in which the activities of the sequence include at least one of product recommendation or prescription by a physician, dispensing of the product to the end user, and use of the product by the end user.

19. The method of claim 7 in which the attributes comprise geography.

20. An apparatus comprising
a processor to maintain an association between a promotional campaign for a pharmaceutical product, and an identifier that is unique with respect at least one of the campaign, the product, or a stakeholder associated with the product, and
storage to store, in association with the unique identifier, information about at least one of the following: the campaign, the product, the stakeholder, or activities of the stakeholder with respect to the product.

21. An apparatus comprising
means for maintaining an association between a promotional campaign for a pharmaceutical product, and an identifier that is unique with respect at least one of the campaign, the product, or a stakeholder associated with the product, and
means for storing, in association with the unique identifier, information about at least one of the following: the campaign, the product, the stakeholder, or activities of the stakeholder with respect to the product.

22. A computer-implemented method comprising
with respect to a promotional campaign for a pharmaceutical product, sending messages to mobile devices of stakeholders associated with the product, the messages being based on actionable attributes of the campaign and identified based on a unique identifier associated with the campaign.
